(19) United States
(12) Patent Application Publication
(10) Pub. No.: US 2007/0069180 A1
(43) Pub. Date: Mar. 29, 2007

(54) METHOD FOR SYNTHESIZING PHOSPHORESCENT OXIDE NANOPARTICLES

(75) Inventors: Yiguang Ju, Pennington, NJ (US); Xiao Qin, Hillsborough, NJ (US)

Correspondence Address: SYNNESTVEDT LECHNER & WOODBRIDGE LLP, P O BOX 592, 112 NASSAU STREET, PRINCETON, NJ, 08542-0592, US

(73) Assignee: TRUSTEES OF PRINCETON UNIVERSITY, Princeton, NJ (US)

(21) Appl. No.: 11/537,035

(22) Filed: Sep. 29, 2006

Related U.S. Application Data
(60) Provisional application No. 60/721,917, filed on Sep. 29, 2005.

(51) Int. Cl. C09K 11/08

(52) U.S. Cl. 252/301.4 R; 252/301.4 F; 252/301.6 R; 252/301.6 F; 252/301.4 S; 252/301.6 S

(57) ABSTRACT

A process is provided for producing substantially monodisperse phosphorescent oxide nanoparticles with rare earth element dopants uniformly dispersed therein, in-which a soluble salt of one or more oxide-forming host metals and a soluble salt of one or more rare earth elements are dissolved in a polar solvent in which the rare earth element salts are soluble to form a precursor solution; droplets of the solution having a particle size less than about 20 microns are suspended in an inert carrier gas; the carrier gas with droplets suspended therein is contacted with a flame fueled by a reactive gas; and the suspended droplets are uniformly heated in the flame to a reaction temperature sufficient to form active radicals that accelerate the formation of activated phosphorescent oxide nanoparticles with uniform rare earth ion distribution. Rare earth doped monodisperse activated cubic phase phosphorescent oxide nano-particles are also disclosed.

### CROSS-REFERENCE TO RELATED APPLICATIONS

This application claims the benefit of U.S. Provisional Application Ser. No. 60/721,917 filed Sep. 29, 2005, the disclosure of which is hereby incorporated by reference herein.

### STATEMENT REGARDING FEDERALLY SPONSORED RESEARCH

The U.S. Government has a paid-up license in this invention and the right in limited circumstances to require the patent owner to license others on reasonable terms as provided for by the terms of grant DMR-0303947 awarded by the National Science Foundation.

### FIELD OF THE INVENTION

This invention relates to a flame synthesis method for synthesizing monodispersed, phosphorescent oxide nanoparticles. In addition, the invention relates to oxide nanoparticles prepared by flame synthesis.

### BACKGROUND OF THE INVENTION

In recent years nanoparticle technology has become a research focus as its fundamental and practical importance becomes more widely known, especially in the case of luminescent materials. For example, phosphorous nanoparticles, such as doped phosphorescent oxide salt particles, exhibit unique chemical and physical properties when compared with their bulk materials, their properties being halfway between molecular and bulk solid state structures. An example would be quantum confinement effects, which brings electrons to higher energy levels, leading to novel optoelectronic properties. Nanoparticles are also finding use in optical, electrical, biological, chemical, medical and mechanical applications and can be found in television sets, computer screens, fluorescent lamps, lasers, etc.

Various methods such as, thermal hydrolysis, laser heat evaporation, chemical vapor synthesis, microemulsion spray pyrolysis, and pool flame synthesis have been used to prepare “nano-sized” oxide salt particles or phosphors. However, these methods generally require either high temperatures, long processing times, repeated milling, the addition of flux, or washing with chemicals, to obtain the desired multi-component oxide particle.

Low temperature methods, such as sol-gel and homogenous precipitation, have also been used to synthesize phosphors, such as, for example, yttrium silicate phosphors. However, yttrium silicate powders synthesized using sol-gel techniques have low crystallinity and require post-treatment or annealing at high temperature to crystallize. In low temperature synthesis, an annealing step at a temperature of from about 927 degrees Celsius (° C.) to about 1300° C. for about 6 hours or more is required to achieve uniform ion incorporation and increase efficiency. The annealing step, as well as the afore-mentioned high temperature processes, can increase particle size through agglomeration and also result in contamination.

Additionally, low temperature processes of producing phosphors, especially rare earth doped phosphors, tends to lead to non-uniform ion incorporation, resulting in a quenching limit concentration of between about 5% and about 7%. The non-uniform ion incorporation produces variations in the distance between ions, with some ions so close that ion-ion interactions produce quantum quenching. This increases as ion concentration increases until a concentration is reached above which decreased fluorescence results. This is defined as the quenching limit concentration.

Therefore, a process is needed for producing particles with more uniform ion incorporation having higher quenching limit concentrations

Flame spray pyrolysis (FSP), also called liquid flame spray (LFS) or flame spray hydrolysis, is a method for producing a broad spectrum of functional nano-particles. The heat released from the combustion of a gaseous or liquid fuel and the precursor itself can provide the high temperature environment which is favorable to phosphor synthesis and activation. The flame temperature and particle residence time are parameters that aid in determining the characteristics of the particles. These parameters can be controlled by varying fuel and oxidizer flow rates. Additionally, particle size can be controlled by varying precursor solution concentration with smaller particles resulting from higher rare earth metal concentrations. Multi-component particles can also be obtained by adding stoichiometric ratios of different rare earth salts into the solution. This technique can be scaled up with high production rates for the manufacture of commercial quantities of nanoparticles.

In flame spray pyrolysis, rare earth phosphors can be prepared by dissolving a water soluble salt of an oxide forming metal in an aqueous or non-aqueous polar solvent with a stoichiometric quantity of a water-soluble salt of one or more rare earth elements, so that a solution of ions of the oxide-forming host metal and the rare earth element dopants is formed.

Several studies have been done using FSP methods. For example, Kang et al., Jpn. J. Appl. Phys., 40, 4083 (2001), synthesized Y₂O₃:Eu phosphor nanoparticles with an average particle size of about 1 micron (μm). The synthesized particles were dense with a spherical morphology. Additionally, the particles were finer than the particles produced by general spray pyrolysis and had a monoclinic phase with small impurities of the cubic phase.

In another study, Tanner et al., J. Phys. Chem. B, 108, 136 (2004) synthesized Y₂O₃:Eu nanoparticles using preformed sol, spray pyrolysis and flame spray pyrolysis methods and compared their luminescence properties.

In yet another study, Chang et al., Jpn. J. Appl. Phys., 43, 3535 (2004) synthesized cubic nanocrystalline Y₂O₃:Eu phosphors using an FSP method without any post-heat treatments. The XRD spectrum of the as-prepared particles shows a cubic phase particle with high crystallinity. This indicates that in flame spray pyrolysis, the precursor composition plays a role in achieving the desired product properties.

Previous studies have found that the particles properties such as emission lifetime, luminescent efficiency, and concentration quenching limit of the luminescent particles depend on particle size, crystal structure, hydroxyl residuals, and particle uniformity. However, these as well as other previous attempts to produce phosphorescent oxide nanoparticles using FSP methods have been largely unsuccessful because of issues with particle agglomeration and particle sizes on the micron scale. There remains a need for a method for producing nano-scale phosphorescent oxide particles.

### BRIEF SUMMARY OF THE INVENTION

The present invention is directed to a method for producing substantially monodispersed, phosphorescent oxide nanoparticles of high crystallinity without high annealing temperatures. Additionally, the phosphorescent oxide nanoparticles have improved quenching limit concentrations thereby satisfying at least some of the needs described above.

According to one aspect of the present invention, a process is provided for producing activated substantially monodispersed phosphorescent oxide nanoparticles with rare earth element dopants uniformly dispersed therein, in which a soluble salt of one or more oxide-forming host metals and a soluble salt of one or more rare earth elements is dissolved in a polar solvent in which the rare earth element salts are soluble to form a precursor solution; droplets of the solution having an average particle size less than about 20 μm, and preferably less than about 5 μm, are suspended in an inert carrier gas; the carrier gas with the droplets suspended therein is contacted with a flame fueled by a reactive gas; and the suspended droplets are uniformly heated in the flame to a reaction temperature sufficient to form active radicals that accelerate the formation of activated phosphorescent oxide nanoparticles with uniform rare earth ion distribution.

According to one embodiment of this aspect of the invention, the precursor solution is sonicated generating fine spray droplets that are suspended in the inert carrier gas. According to another embodiment of this aspect of the invention, the droplets have a particle size between about 1 and about 10 μm. According to yet another embodiment of this aspect of the invention, the precursor solution is heated to a temperature between about 40° C. and about 50° C.

According to one embodiment of this aspect of the invention, the polar solvent is an aqueous solvent. According to another embodiment of this aspect of the invention, the aqueous solvent contains only water. According to another embodiment of this aspect of the invention, the polar solvent contains ethanol. According to another embodiment of this aspect of the invention, the polar solvent is non-aqueous. According to yet another embodiment of this aspect of the invention, the non-aqueous solvent contains ethanol.

According to another embodiment of this aspect of the present invention, the heating step delivers a co-flow of air to the flame wherein the flow rates of the air, the carrier gas and reactive gas to the flame are effective to provide a predetermined particle size and quenching limit concentration. According to another embodiment of this aspect of the invention, the air is delivered to the flame separately from the carrier gas. According to another embodiment of this aspect of the invention, the air is delivered to the flame in admixture with the carrier gas. According to another embodiment of this aspect of the invention, the reactive gas includes a plurality of reactive gases, including oxygen. According to yet another embodiment of this aspect of the invention, the plurality of reactive gases includes methane.

In yet another aspect of the present invention, rare earth doped mono-dispersed activated phosphorescent oxide nanoparticles are provided, consisting essentially of cubic phase particles having an average particle size between about 50 nanometers and about 20 microns nanometers and a quenching limit concentration between about 1 and about 30 mol. %. A particle size between about 50 and about 100 nanometers is preferred.

These and other features, aspects, and advantages of the present invention will become better understood with regard to the following description, appended claims, and accompanying drawings where:

### BRIEF DESCRIPTION OF THE DRAWINGS

FIGS. 1a and 1b show schematics of two variations of a flame spray pyrolysis system.

FIGS. 2a and 2b, show scanning electron micrographs (SEM's) of Y₂O₃:Eu particles produced by flame spray pyrolysis using distilled water (DI) as a phosphor-precursor solvent.

FIGS. 2c and 2d, show scanning electron micrographs (SEM's) of Y₂O₃:Eu particles produced by flame spray pyrolysis using ethanol as a precursor solvent.

FIG. 3, shows the size distribution of the particles corresponding to the SEM's in FIGS. 2a-2d.

FIG. 4, shows the temperature distribution along the centerline for the flames corresponding to SEM images in FIGS. 2a and 2c.

FIG. 5, shows XRD spectra of various Y₂O₃:Eu particles.

FIG. 6, shows photoluminescence spectra of various Y₂O₃ :Eu nanoparticles prepared from various concentrations of ethanol and water.

FIG. 7, shows the effect of temperature on photoluminescence intensity for Y₂O₃:Eu prepared with an ethanol precursor.

FIG. 8, shows a photoluminescence spectrum of Y₂O₃:Eu nanoparticles at different doping concentrations.

### DETAILED DESCRIPTION OF THE INVENTION

According to the present invention, a method is provided for the synthesis of rare-earth doped phosphorescent oxide nanoparticles. The method further provides for homogeneous ion distribution through high temperature atomic diffusion.

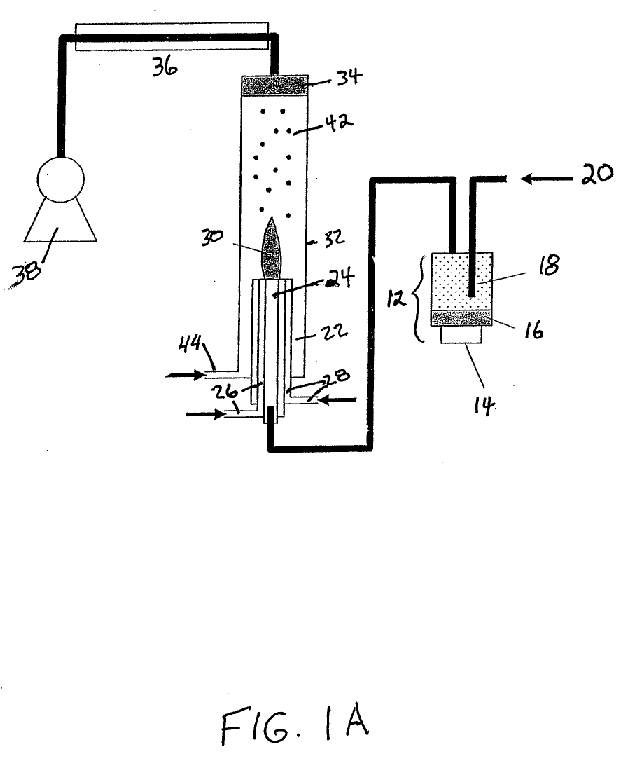

FIGS. 1a and 1b, depict flame spray pyrolysis systems consistent with the present invention. The system includes a spray generator apparatus 12 comprising an ultrasonic vibrator 14 and rare earth host-metal precursor solution 16; a reactor 32 that houses the flame nozzle 22 and flame 30; and a particle collection subsystem comprising a filter 34, chiller 36, and vacuum pump 38.

A rare earth-host metal precursor solution (hereinafter referred to as “the phosphor-precursor solution” or “the precursor solution”) is prepared by dissolving stoichiometric quantities of soluble salts of one or more oxide-forming host metals and soluble salts of one or more rare earth elements in a polar solvent (not shown). Stoichiometric amounts of host metal and rare earth element are employed to provide rare earth element doping concentrations in the final particle of at least 1 mol. % and up to the quenching limit concentration, which can be readily determined by one of ordinary skill in the art without undue experimentation.

The present invention provides significant improvement in quenching limit concentrations, which range between about 1 and about 30 mol %, depending on the hosts and activators. For example, for the case of Y₂O₃:Eu prepared according to the method of the present invention, 18 mol. % is the quenching limit concentration. For Y₂SiO₅:Eu prepared according to the method of the present invention, 30 mol. % is the quenching limit concentration. For Y₂O₃:Er prepared according to the method of the present invention, depending on the particle size, the quenching limit concentration lies in the range of 1 to about 10 mol. %.

The water-soluble rare earth element salts include, but are not limited to, salts represented by the formula:
REX₃.yH₂O

wherein RE is a rare earth element, y is 4, 5, 6 or 7 and X is an anion forming a water or alcohol soluble salt such as carbonate, hydroxide, halide, nitrate, and the like. Any rare earth element or combinations thereof can be used (i.e., europium, cerium, terbium, dysprosium, holmium, erbium, thulium, ytterbium, lutetium, etc.) with europium, cerium, terbium, holmium, erbium, thulium and ytterbium being preferred, and the following combinations also being preferred: ytterbium and erbium, ytterbium and holmium and ytterbium and thulium. Strontium can also be used, and for purposes of the present invention, rare earth elements are defined as including strontium. The oxide forming host metal can be, but is not limited to, lanthanum, yttrium, lead, zinc, cadmium, and any of the Group II metals such as, beryllium, magnesium, calcium, strontium, barium, aluminum, radium and any mixtures thereof or a metalloid selected from silicon, germanium and II-IV semi-conductor compounds.

Suitable polar solvents used in the preparation of the precursor solution include, for example, ethanol, water, ethanol, methanol, isopropanol, n-propanol, n-butanol, hexanol, ethylene glycol, and combinations thereof. The overall molar concentration of the oxide-forming host metal salt(s) and rare earth element salt(s) in the polar solvent can be from about 0.0001 to about 2.0 M. The concentration is preferably between about 0.01 to about 0.5 M and more preferably between about 0.05 to about 0.1 M. Higher concentration precursor solutions produce larger particles.

The precursor solution may optionally contain a predetermined amount of a silicon-containing material, such as, but not limited to, tetraethyl ortho-silicate, fumed silica, or hexamethyldisiloxane to synthesize rare earth doped silicates.

The precursor solution may optionally contain a predetermined amount of a sulfur-containing material, such as, but not limited to, dithiooxamide, thiourea, or thioacetamide to synthesize rare earth doped oxysulfides.

The precursor solution 16 is placed into an ultrasonic vibrator 14 wherein fine spray droplets 18 are generated having diameters between about 1 and about 10 microns, more preferably between about 3 and about 7 microns, and typically about 5 microns. Essentially any means of forming droplets with a particle size less than about 20 microns can be used. Once the precursor solution is atomized, an inert carrier gas 20 such as, but not limited to, nitrogen, argon, helium, and mixtures thereof, transports the droplets 18 through a central tube 24 to a quartz reactor 32 comprising a coflow burner 22 and flame 30.

FIG. 1a, depicts an embodiment wherein coflow burner 22 has three concentric tubes 24, 26, and 28. Central tube 24 transports fine spray droplets 18 to the reactor, while tubes 26 and 28 co-deliver two reactive gases. In the depicted embodiment, tube 26 delivers methane and tube 28 delivers oxygen. The reactive gas inlets can be any size depending upon the desired gas delivery rate.

A flame produces active atomic oxygen via a chain-initiation reaction:
H+O₂=OH+O (i)

A high concentration of oxygen in the flame activates and accelerates the oxidation of rare-earth ions and host materials through a series of reactions:
R+O→RO; (ii)
RO+O→ORO; and (iii)
ORO+RO→R₂O₃ (iv)

Reactions (ii) through (iv) are much faster than the oxidation reaction in low temperature processing represented by the reaction below;
2R+3/2O₂=R₂O₃ (v)

The reaction represented by formula (v) has a much higher energy barrier than the reactions in formulae (i)-(iv) in which radicals formed in flames diffuse and help produce faster ion incorporation.

As depicted in FIG. 1 a, fine spray droplets 18 are transported to flame nozzle 22 and into the centerline of flame 30 wherein the droplets pyrolyze to form mono-dispersed, phosphorescent oxide nanoparticles 42. Tube 44 introduces an air coflow into quartz reactor 32. By varying the coflow rate of methane, oxygen, air, and inert carrier gas, the flame temperature and particle residence time in the flame can be controlled. As residence time increases, the particles agglomerate and grow in size.

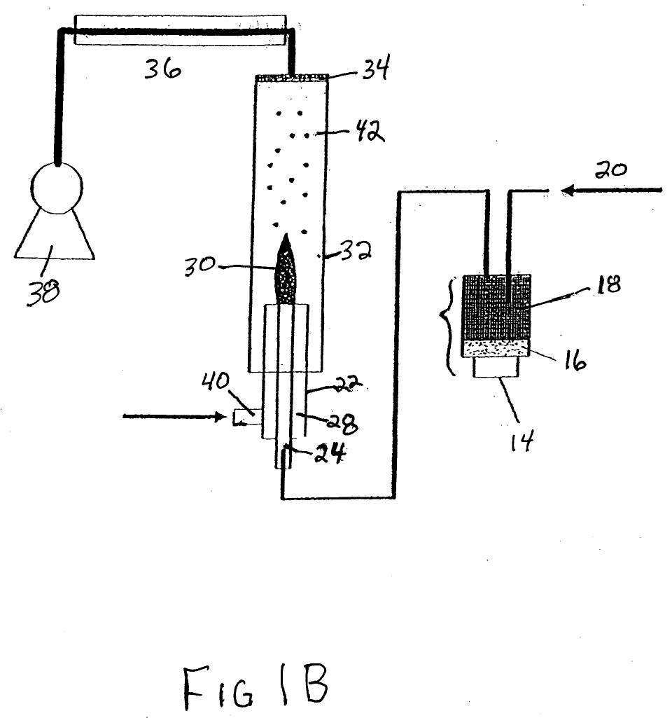

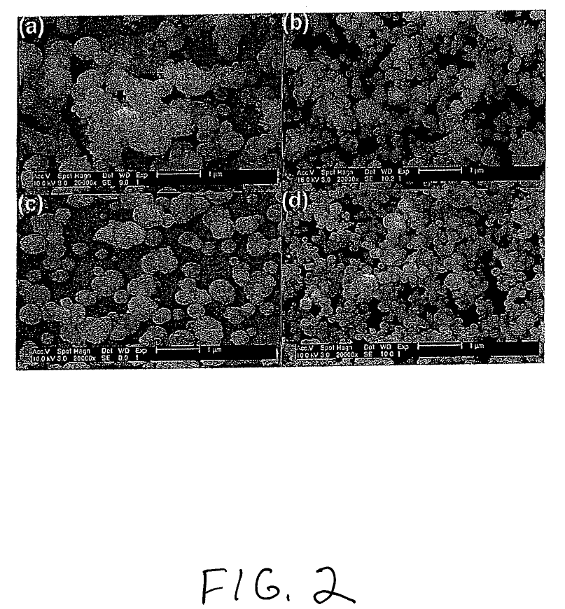

Generally, in flame spray pyrolysis a higher flame temperature increases particle sintering and agglomeration. However, this was not the case in the current work as seen in FIG. 2a-d wherein spherical, discrete particles are seen. It is proposed that in addition to residence time, the initial droplet size and precursor concentration are the dominant factors that determine final particle size. This could explain why, even at higher temperatures, the nanophosphors produced using ethanol as the precursor solution were smaller than when using water as the precursor solution. For example, ethanol has a lower boiling point and enthalpy of evaporation than water. As ethanol passes through the flame, it directly reacts and releases heat to the flame increasing flame temperature, whereas water takes heat away. Assuming droplets of the same size, the ethanol droplet needs much less residence time in the flame for the droplet to vaporize than does the water droplet.

By increasing the flame temperature, the precursor solvent evaporates more quickly resulting in the ability to use shorter flame residence times to produce smaller particles. The same result can also be obtained by reducing the delivery rate of the precursor solution to reduce the amount of solvent to evaporate, while maintaining or increasing the delivery rate of coflow air and reactive gases. Or, a combination of both parameter adjustments can be used. However, everything being equal, a higher flame temperature generally gives larger particles as does larger droplet sizes and longer residence time in the flame.

Essentially cubic phase particles are obtained having an average particle size between about 50 nanometers and about 200 microns, and preferably between about 50 and about 100 nanometers. The particles exhibit quenching limit concentrations heretofore unobtained.

Temperatures between about 1800 and about 2900° C. are preferred, with temperatures between about 2200 and about 2400° C. more preferred. Temperatures within this range produce monodispersed rare earth doped activated oxide nanoparticles without significant agglomeration having an essentially uniform distribution of rare earth ions within the particles. Actual residence time will depend upon reactor configuration and volume, as well as the volume per unit time of precursor solution delivered at a given flame temperature.

The flame temperature can be manipulated by adjusting the flow rates of the gas(es). For example, the temperature of the flame can be increased by increasing the methane flow rate in a methane/oxygen gas mixture. Guided by the present specification, one of ordinary skill in the art will understand without undue experimentation how to adjust the respective flow rates of reactive gas(es), coflow air and inert carrier gas to achieve the flame temperature producing the residence time required to obtain an activated particle with a predetermined particle size.

The flame temperature can also be manipulated by the choice of precursor solution solvent. As mentioned above, ethanol has a lower boiling point and enthalpy of evaporation (78° C. and 838 kJ/kg) than water (100° C. and 2258 kJ/kg). Furthermore, ethanol is a fuel that directly reacts and releases heat to the flame, unlike water, which absorbs heat. Under identical condition, therefore, precursor solutions of ethanol and similar polar organic solvents will produce higher combustion temperatures than aqueous precursor solutions.

FIG. 1b, shows another embodiment with only one reactive gas delivery tube that also delivers the coflow air through the coflow burner. Coflow flame nozzle 22 comprises two concentric tubes 24 and 28. The fine spray droplets 18 are transported through the central tube 24 and the reactive gas for the flame 30 is supplied through a single tube 40 with the coflow air. In the depicted embodiment methane and coflow air are co-delivered through tube 40.

Any reactive gas can be used singularly or in combination to generate the flame for reacting with the precursor solution, such as, but not limited to, hydrogen, methane, ethane, propane, ethylene, acetylene, propylene, butylenes, n-butane, iso-butane, n-butene, iso-butene, n-pentane, iso-pentane, propene, carbon monoxide, other hydrocarbon fuels, hydrogen sulfide, sulfur dioxide, ammonia, and the like, and mixtures thereof. A hydrogen flame can produce high purity nano-phosphors without hydrocarbon and other material contamination.

In the depicted embodiments, the flame length determines particle residence time within the flame. Higher temperatures produce satisfactory nanoparticles with shorter flames. Flame length is similarly manipulated by varying gas flow rates, which is also well understood by the ordinarily skilled artisan. Increasing the flame length increases the residence time of the particles in the flame allowing more time for the particles to grow. In a typical coflow nonpremixed flame, the increase of fuel stream flow rate will increase the flame length, while the increase of oxidant stream flow will decrease the flame length. The particle residence time can be controlled by varying the different flow rates of the gases, and is readily understood by one of ordinary skill in the art guided by the present specification.

FIGS. 1a and 1b show a particle collection subsystem 44 comprising a filter (or filtering system) 34, chiller 36, and vacuum pump 38. The filter or filtering system 34 is arranged atop the reactor 32 for gathering the formed nano-phosphor particles. Vacuum pump 38 extracts gases and heat from the reactor 32 through chiller 36, thereby cooling and condensing the evaporated solvent vapor, which is then recycled or exhausted. Vacuum pump 38, and provides the force necessary to extract the formed nano-phosphor particles 42 from the reactor 32 onto the filter and/or filter bags 35, on which the formed nano-phosphor particles 42 are collected.

Although the particle collection subsystem has been described in a certain embodiment, it is understood that the particle collection subsystem can be designed using any filtering, chilling, or collection system as is known in the art and is not restricted to any particular configuration.

The present invention thus provides a combustion method for the synthesis of phosphor nanoparticles employing a wide range of precursors from which a broad spectrum of functional nanoparticles can be prepared through broad control of flame temperature, structure and residence time. The following non-limiting examples are merely illustrative of some embodiments of the present invention, and are not to be construed as limiting the invention, the scope of which is defined by the appended claims. All parts and percentages are molar unless otherwise noted and all temperatures are in degrees Celsius.

### EXAMPLES

The effect of precursor solutions on particle formation, morphology, particle size distribution, crystal structure, and photoluminescence using ethanol and water as precursor solvents were investigated. Additionally, concentration quenching limits were also investigated.

In the following examples, an ultrasonic spray generator operating at about 1.7 MHz generated the fine spray droplets. A nitrogen carrier gas transported the droplets through a 5.3 mm central pipe to a flame nozzle. The flame nozzle was three concentric pipes of carrier gas, methane and oxygen. An air coflow was introduced into the reactor. Flame temperature and particle residence time was controlled by varying the flow rate of fuel, oxidant and coflow air. The typical flow rates of nitrogen, methane and oxygen gases are 0.3, 0.3 and 1.5 L/min., respectively, which results in an adiabatic flame temperature of 2628 K. Uncoated 100 micron diameter R-type wire thermocouples with a junction bead diameter of about 350 plus or minus 30 microns that were corrected for radiation heat losses were used for temperature measurements along the centerline.

The particles were collected as powder at ambient temperatures using a micron glass fiber filter (whatman GF/F) located about 30 cm above the flame. The particles were pasted on a quartz glass holder and a scan was conducted in a range of 10 degrees to 60 degrees (20) using a powder X-ray diffractometer (XRD, 30 kV and 20 mA, CuKa, Rigaku Miniflex) and crystal phase identification. An estimation of crystalline size was performed.

Morphology and particle size were determined using a field-emission scanning electron microscope (FE-SEM, Philips XL30). A photoluminescence spectrum of the resulting samples was measured with a Jobin-Yvon Fluorolog-3 fluorometer equipped with a front face detection set-up and two double monochromators. Samples were excited at 355 nm with a 150 watt Xenon lamp and a 2 nanometer (nm) slit width was used for both monochromators. The samples were collected on micron glass fiber filters and all samples were examined at 25° C.

Effect of Precursor Solvent and Solvent Concentration on Particle Formation

Using ethanol and water as solvents, the effect of precursor solvent on nano-phosphor particle formation was investigated. The starting precursor solutions were prepared by dissolving a known amount of yttrium and europium nitrate [Y(NO₃)₃.H₂O and Eu(NO₃)₃.H₂O, 99.9 percent, Alfa Aesar] in 1) distilled water; and 2) ethanol. Ethanol concentration levels were from about 0.1 M to about 0.001 M and the doping concentration of europium (Eu) was from about 3 mol percent to about 21 mol percent with respect to yttrium.

FIGS. 2(a-d), shows scanning electron micrographs (SEM's) of Y₂O₃:Eu nanoparticles produced by flame spray pyrolysis using DI water (FIG. 2a and FIG. 2b) and ethanol (FIG. 2c and FIG. 2d) as the solvent for making the rare earth host-metal oxide precursor solution. Precursor concentration was as follows: The concentration in FIG. 2a and FIG. 2c was 0.1 M. The concentration in FIG. 2b and FIG. 2d was 0.01M. The europium doping concentration was 6 mol percent, with respect to yttrium, for all cases.

The results confirm that higher concentration precursor solutions produce smaller particles than made using lower concentration precursor solutions. In addition, the nano-phosphor particles made using DI water as the precursor solvent had small hair-like projections on the surface and a broader particle size distribution than the nano-phosphor particles made with ethanol as the precursor solvent. Additionally, the nano-phosphor particles made using ethanol as the precursor solvent had a smoother surface when compared with the particles made using DI water and did not have hair-like projections on their surface. All particles had a spherical morphology regardless of precursor solvent type or concentration.

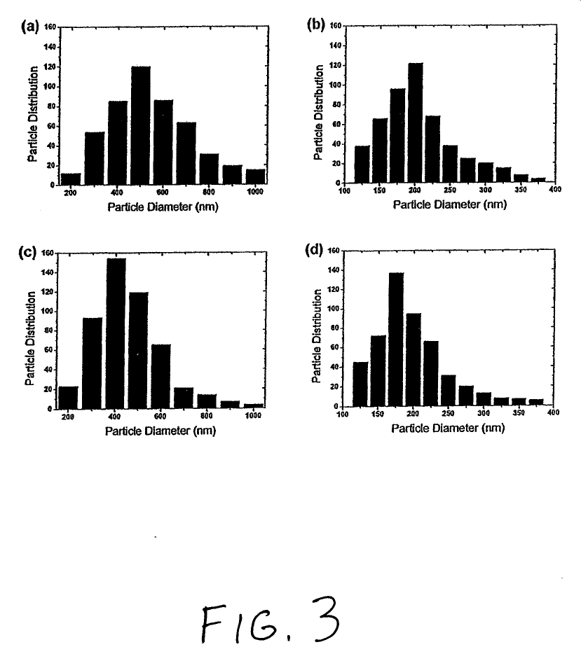

FIG. 3, shows particle size distributions corresponding to the particles in the micrographs of FIG. 2a-2d. The distribution was determined by measuring the diameters of 500 particles from the SEM images. The particles prepared using ethanol as a precursor solvent exhibited narrower particle size distributions and smaller average particle sizes (APS) than the particles produced using DI water as the precursor solvent at the same concentrations.

TABLE 1

| | Precursor | | | Geometric | Flame |
|---|---|---|---|---|---|
| | Concentration | Precursor | Average Particle | Standard | Temperature* |
| Case | (M) | Solvent | Size (nm) | Deviation | (° C.) |
| 1 | 0.1 | Water | 535 | 1.20 | 1447 |
| 2 | 0.01 | Water | 192 | 1.31 | 1447 |
| 3 | 0.1 | Ethanol | 412 | 1.14 | 1747 |
| 4 | 0.01 | Ethanol | 198 | 1.10 | 1747 |
| 5 | 0.001 | Ethanol | 114 | 1.07 | 1747 |

*At centerline location of 10 cm above the burner exit

Table 1 lists the APS and geometric standard deviation calculated from the SEM images at different precursor concentration. Average particle size increased as solvent concentration increased. Atomized droplet size can be related to the surface tension (T) and density (ρ) of the precursor solution, and the ultrasonic nebulizer frequency (f). The average droplet size (D) can be approximately determined by D=C[T/(pf²)]⁻³, where C is a constant. Substituting the properties of water and ethanol into this relation, the average size of a water droplet is 1.6 times larger than that of ethanol. The smaller ethanol droplet size leads to a smaller final particle size. Additionally, when the concentrations of water and ethanol are the same, the mean diameter of the particles produced using water is larger than the particles made using ethanol as the solvent. These results show precursor solvent composition effects particle size and morphology.

Effect of Flame Temperature on Nano-phosphor Particle Morphology and Size Distribution

In the following examples, the effect of flame temperature on morphology and particle size distribution of synthesized Y₂O₃:Eu nanoparticles was investigated. The adiabatic flame temperature at equilibrium state was calculated using the CHEMKIN II software package developed by Sandia National Laboratories, where CH₄, O₂, N₂, H₂O and C₂H₅OH were considered as reactants and CH₄, O₂, N₂, H₂O, CO₂, CO, H, OH, O, N, NO, and NO₂ were used as products.

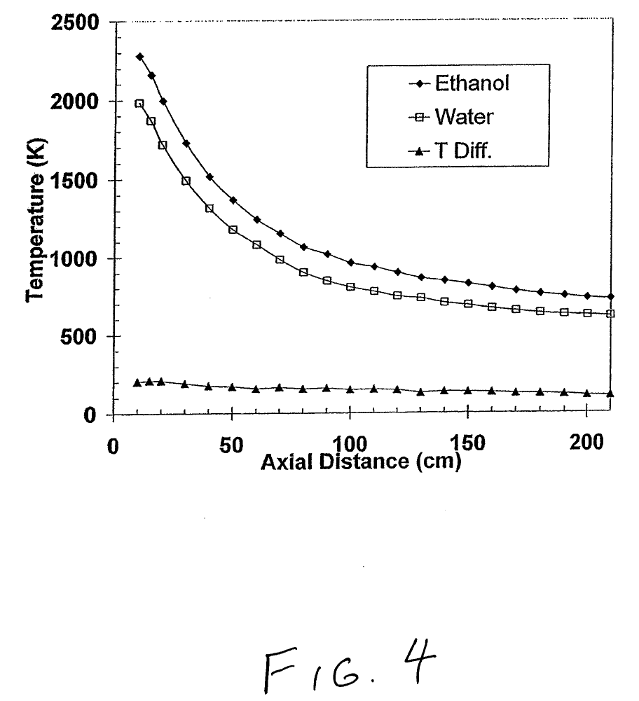

FIG. 4, shows the temperature profiles along the centerline for flames corresponding to FIGS. 2a and 2c. Flow rates for the methane, oxygen, nitrogen and co-flow air were kept constant at 0.169 L/min, 1.51 L/min, 0.200 L/min, and 2.60 L/min, respectively, in the two cases. The temperature was measured about 10 cm above the core or burner exit of the methane-oxygen flame. The adiabatic flame temperature calculated from the CHEMKIN II software package was 1855° C. for both flames. Air co-flow was not considered and the flow rate of ethanol or water was about 8.67×10⁻² ml/min and was negligible in the equilibrium temperature calculation. Results confirm that the temperature of the flame using ethanol as the precursor solvent is higher than the temperature of the flame using DI water as the precursor solvent.

Effect of Flame Temperature on Morphology and Particle Size Distribution

In this example, the effect of the flame temperature on the morphology of the Y₂O₃:Eu nanoparticles and particle size distribution was investigated except that the methane flow rate was varied. The oxygen, nitrogen and air flow rates were constant at 1.5 1 L/min, 0.213mL/min, and 3.18 L/min, respectively, while adjusting the methane flow rate to 0.1 15 L/min, 0.169 L/min, and 0.223 L/min for the flame in which 0.01 M ethanol was the precursor solvent. Adjusting the methane flow rate resulted in flames with an adiabatic temperature of 1422° C., 1862° C., and 2158° C. corresponding to the methane flow rate of 1.51 L/min, 0.213mL/min, and 3.18 L/min, respectively.

TABLE 2

| | Flame | | Average | Geometric |
|---|---|---|---|---|
| | Temperature* | Adiabatic Flame | Diameter | Standard |
| Case | (° C.) | Temperature (° C.) | (nm) | Deviation |
| 1 | 1266 | 1422 | 185 | 1.07 |
| 2 | 1619 | 1862 | 198 | 1.10 |
| 3 | 1857 | 2158 | 214 | 1.09 |

At centerline location of 20 cm above the burner exit

These results show average particle size increase at higher temperatures.

Effect of Precursor Solvent on Nano-phosphor Crystal Structure

In this example, the effect of precursor solvent on the crystal structure of the nanoparticle was investigated.

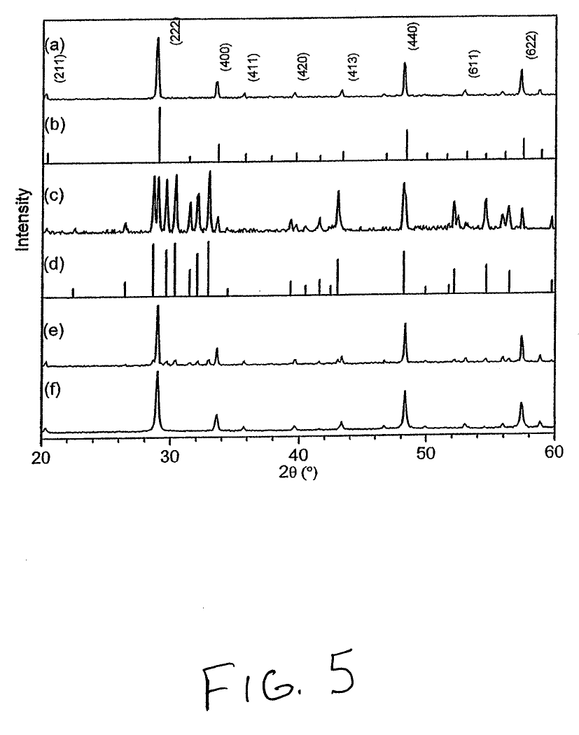

FIG. 5, shows XRD patterns of 6 different Y₂O₃:Eu nanoparticles. Water and ethanol were used as solvents in making the precursor solutions. FIG. 5a, shows the XRD pattern for the Y₂O₃:Eu nanoparticles prepared using water as the precursor solvent. This indicates a cubic structure was produced when compared with the International Center for Diffraction Data (ICDD) card number 25-1011 for cubic (Y_{0.95}Eu_{0.05})₂O₃ (see FIG. 5b). No peak of any other phase was detected. Average crystallite size of the particles was calculated using the Scherrer equation:
D=0.89λ/(B cos θ)

where λ=0.1540598 nm is the wavelength of the X-ray, θ is the diffraction angle and B is the full width at half maximum (FWHM) of the XRD peaks (correspondding to 2θ 0respectively); and 0.89 is a constant for spherical particles. The crystallite size for Y₂O₃:Eu nanoparticles in FIGS. 5a, 5c, 5e, and 5f are 41.4 nm, 43.6 nm, 58.4 nm and 56.1 nm, respectively.

The XRD pattern for the Y₂O₃:Eu nanoparticles produced when ethanol was used as the precursor, shows peaks from a cubic phase as well as additional peaks which come from a monoclinic phase of Y₂O₃:Eu. No data was available for monoclinic Y₂O₃:Eu therefore, the additional peaks were compared with monoclinic Y₂O₃ of ICDD card number 44-0399 (FIG. 5d) and the peaks from the monoclinic phase were identified. By increasing methane flow rate and raising the adiabatic flame temperature to 2157° C. in the flame in which water was the precursor solvent, monoclinic phase Y₂O₃:Eu particles were observed (FIG. 5e).

The nanoparticles produced from the ethanol precursor solvent were subjected to annealing at 1200° C. for 2 hours wherein the monoclinic phase converted into a cubic phase completely (see FIG. 5f). Nanoparticles prepared from an ethanol precursor solvent thus convert from the monoclinic to the cubic phase at temperatures significantly lower than nanoparticles prepared from aqueous precursor solutions.

Effect of Precursor Solution on Nano-phosphors Photoluminescence

In this example, the effect of the type of precursor solution used to produce the Y₂O₃:Eu nanoparticles on photoluminescence was investigated.

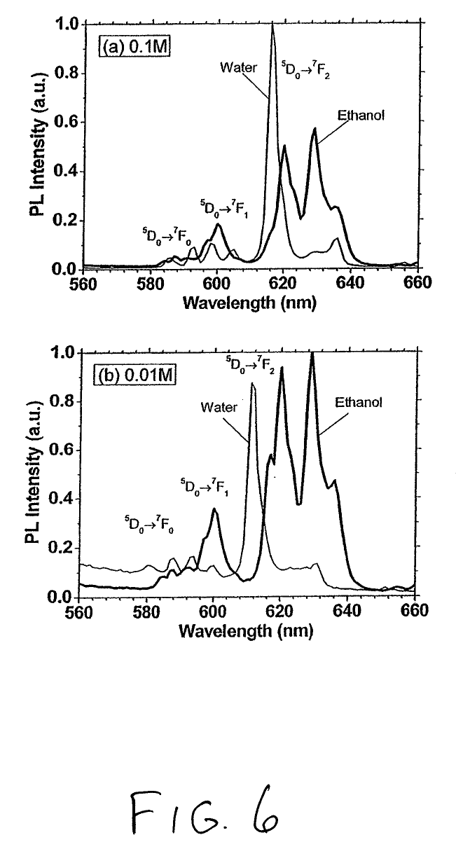

FIG. 6 shows the photoluminescence (PL) spectra of Y₂O₃:Eu nanoparticles exited by ultraviolet (UV) light at a wavelength of 355 nm. The spectrum of the nanoparticles produced when using water as the precursor solvent shows an Y₂O₃:Eu³⁺ emission spectrum. This is described by the ⁵D₀→⁷F_{J} ( J=0, 1, 2 . . . ) line emissions of the Eu³⁺ ions. The emission at 611 nm is a hypersensitive forced electric-dipole emission from ⁵D₀→⁷F₂ transition and the peaks around 600 nm correspond to the ⁵D₀→⁷F₁ transition, which is magnetic dipole emission. The PL spectra of the particles obtained when ethanol is used as the precursor solvent shows a double peak at 615 nm and 624 nm, respectively. These two peaks are caused by the ⁵D₀→⁷F₂ transition from the monoclinic Y₂O₃:Eu. If the nanoparticles produced from using ethanol as the precursor solvent are annealed at 1200° C. for 2 hours, they are transformed from the monoclinic phase into a cubic phase, resulting in a single peak PL spectrum. Results show higher integral PL intensity when water is used as the precursor solvent versus ethanol.

Effect of Flame Temperature on Photoluminescent Intensity

In this example, the influence of flame temperature on PL intensity of particles prepared when ethanol is used as the precursor solvent was investigated. Flame temperature was measured about 20 cm above the burner exit. Temperatures tested were 1266° C., 1619° C., and 1857° C.

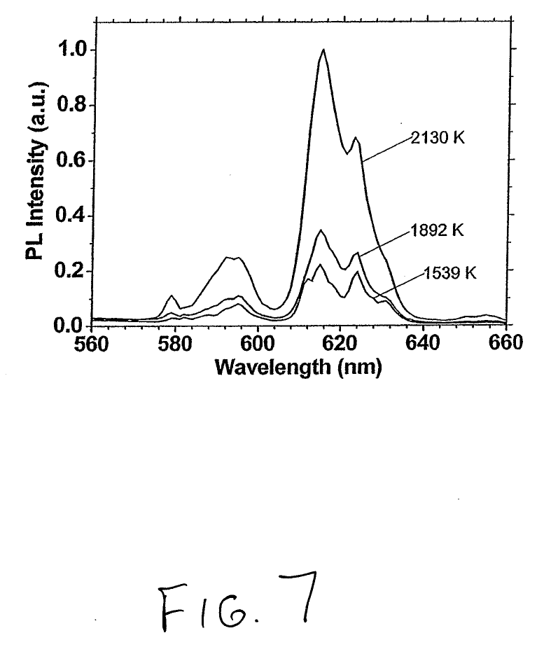

FIG. 7 shows as temperature increased the integral PL intensity increased. Additionally, particles exhibited higher crystallinity at higher temperatures and the brightness of the nanoparticles increased.

Effect of Solvent on Concentration Quenching Limit

When rare earth ion (e.g. Eu³⁺) concentration increases to a certain level (limit level), diminution or quenching of luminescence occurs. Low temperature synthesis methods such as sol-gel lead to non-uniform ion incorporation. As a result the rare earth ion quenching limit is between from about 5 percent to about 7 percent. At higher rare earth concentrations, fluorescence decreases. The present invention produces uniform rare earth ion incorporation because of the increased atomic diffusivity at high flame temperatures (greater than 1927° C. ). Because of the uniform rare earth ion incorporation in flame synthesis (see FIG. 1), the Europium quenching limit in Y₂O₃ hosts is extended to more than 18 percent.

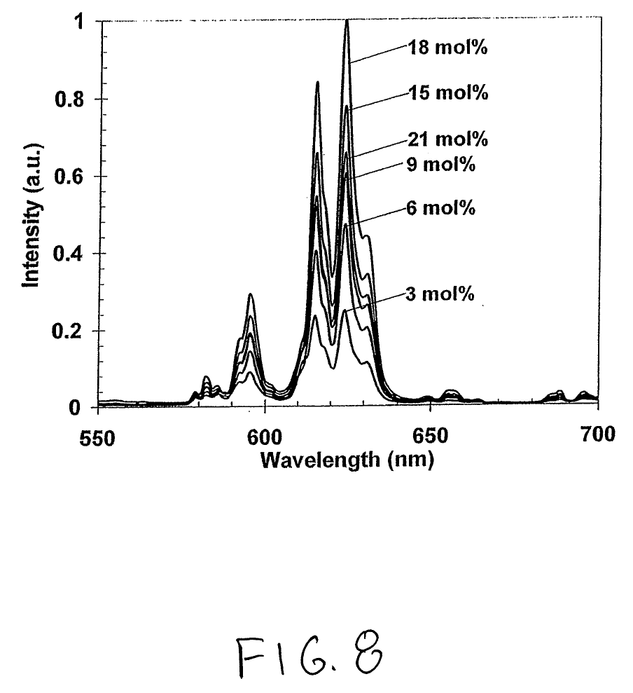

The pairing and aggregation of activator atoms at high concentration may change a fraction of the activators into quenchers and induce the quenching effect. The migration of excitation of resonant energy transfer between Eu³⁺ activators can also incur quenching. Bulk Y₂O₃:Eu phosphor, quenching is known to occur at a concentration of about 6 mol percent europium with respect to yttrium. However, as seen in FIG. 8, the quenching concentration is about 18 mol % for the particles prepared in ethanol in this study.

Phosphors on a nanoparticle scale were thus successfully synthesized by flame spray pyrolysis methods. The results showed that the choice of precursor solvent and flame temperature has significant impact on particle size, morphology (particularly the temperature at which the monoclinic phase converted to the cubic phase), the photo-luminescent intensity and the concentration quenching limit. It was also demonstrated that the particle size could be controlled by varying the precursor concentration, flame temperature and particle residence time. The concentration quenching limit of nano-phosphors made by the present method was found to be higher than previously reported quenching limits of particles having similar particle sizes.

Although the present invention has been described in considerable detail with reference to certain versions thereof, other versions are possible. Therefore, the spirit and scope of the appended claims should not be limited to the description of the versions contained herein.

We claim:

1. A method for producing activated substantially monodisperse, phosphorescent oxide particles with rare earth element dopants uniformly dispersed therein comprising the steps of:
a) dissolving a soluble salt of one or more oxide-forming host metals and a soluble salt of one or more rare earth elements in a polar solvent in which said one or more rare earth element salts are soluble to form a precursor solution;
b) suspending droplets of said precursor solution having a particle size of less than about 20 microns in an inert carrier gas;
c) contacting said inert carrier gas having droplets suspended therein with a flame fueled by a reactive gas; and
d) uniformly heating said suspended droplets in said flame to a reaction temperature sufficient to form active radicals that accelerate the formation of activated phosphorescent oxide nanoparticles with uniform rare earth ion distribution.

2. The method of claim 1, wherein said oxide forming host is a metal selected from the group consisting of lanthanum, yttrium, lead, zinc, cadmium, calcium, berrylium, magnesium, strontium, barium, aluminum, radium and mixtures thereof, or a metalloid selected from the group consisting of silicon, germanium and II-IV semi-conductor compounds.

3. The method of claim 1, wherein said rare earth element salt comprises REX₃-yH₂O, wherein y is 4, 5, 6 or 7, RE is a rare earth element and X is an anion forming a water or alcohol soluble salt selected from the group consisting of carbonate, hydroxide, halide and nitrate.

4. The method of claim 1, wherein said rare earth element is selected from the group consisting of europium, cerium, terbium, dysprosium, holmium, erbium, thulium, ytterbium, lutetium and mixtures thereof.

5. The method of claim 1, wherein said oxide forming host metal and said rare earth element are dissolved in said polar solvent with a silicon-sulfur-containing material.

6. The method of claim 1, wherein said suspending step comprises sonicating said precursor solution.

7. The method of claim 1, wherein said polar solvent is selected from the group consisting of ethanol, water, methanol, isopropanol, n-propanol, n-butanol, hexanol, ethylene glycol and mixtures thereof.

8. The method of claim 7, wherein said polar solvent is an aqueous solvent.

9. The method of claim8, wherein said polar solvent comprises ethanol.

10. The method of claim 7, wherein said polar solvent is non-aqueous.

11. The method of claim 10, wherein said polar solvent comprises ethanol.

12. The method of claim 1, wherein said inert carrier gas is selected from the group consisting of nitrogen, argon, helium and mixtures thereof.

13. The method of claim 1, wherein said reactive gas is selected from the group consisting of methane, hydrogen, ethane, propane, ethylene, acetylene, propylene, butylenes, n-butane, iso-butane, n-butene, iso-butene, n-pentane, iso-pentane, propene, carbon monoxide, hydrogen sulfide, sulfur dioxide, ammonia and mixtures thereof.

14. The method of claim 1, wherein said reaction temperature is between about 1800 and about 2900° C.

15. The method of claim 1, wherein said solvent comprises ethanol and said precursor solution is heated to a temperature between about 40 and about 50° C.

16. The method of claim 1, wherein said uniform heating step comprises delivering a co-flow of air to said flame, wherein the flow rates of said air, carrier gas and reactive gas to said flame are effective to provide a predetermined particle size and quenching limit concentration.

17. The method of claim 16, wherein said air is delivered to said flame separately from said reactive gas.

18. The method of claim 16, wherein said air is delivered to said flame in admixture with said reactive gas.

19. The method of claim 1, wherein said reactive gas comprises a plurality of reactive gases including oxygen, which are separately delivered without premixing to said flame.

20. The method of claim 19, wherein said plurality of reactive gases comprises methane.

21. Rare earth doped monodispersed activated phosphorescent oxide nanoparticles consisting essentially of cubic phase particles having an average particle size between about 50 nanometers and about 20 microns, prepared according to the method of claim 1.

22. The nanoparticles of claim 21, wherein said rare earth dopants are selected from the group consisting of europium, cerium, terbium, dysprosium, holmium, erbium, thulium, ytterbium, lutetium and mixtures thereof.

23. The nanoparticles of claim 22 wherein said rare earth dopant comprises europium.

24. The nanoparticles of claim 21, comprising at least one oxide selected from the group consisting of lanthium, yttrium, lead, zinc, cadmium, berrylium, magnesium, calcium, strontium, barium, aluminum and radium oxides, or a metalloid selected from the group consisting of silicon, germanium and II-IV semiconductor compounds.

25. The nanoparticles of claim 21, comprising europium doped yttrium oxide.

26. The nanoparticles of claim 21, comprising particles with an average particle size between about 50 and about 100 nanometers.

27. The nanoparticles of claim 21, wherein said oxide is a silicate or oxyulfide.
